(19) United States
(12) Patent Application Publication
(10) Pub. No.: US 2003/0094169 A1
(43) Pub. Date: May 22, 2003

(54) Cooking device

(76) Inventor: J. Michael Anthony Alden, Palatine, IL (US)

Correspondence Address: Wallenstein & Wagner, Ltd., 53rd Floor, 311 S. Wacker Drive, Chicago, IL, 60606-6630, US

(21) Appl. No.: 09/989,313

(22) Filed: Nov. 20, 2001

(51) Int. Cl. A47J 37/00; F24B 3/00

(52) U.S. Cl. 126/25 R; 126/9 R; 126/50

(57) ABSTRACT

The present invention provides a cooking device 10 for use with a cooking chamber 14 of a barbecue grill assembly 12. The cooking device 10 comprises a top wall 32, a flange 36 extending radially outward from the top wall 32, and a recessed central portion 44 depending radially inward from the top wall 32. The flange 36 has at least one engaging surface 38 and at least one aperture 40 adapted to vent heat from the cooking chamber 14. The engaging surface 38 is adapted to engage an inner surface 52 of the cooking chamber 14 and support the device 10 above a heat source 18. The top wall 32 defines an uppermost surface 49, which is positioned at height above the flange 36. The uppermost surface 49 is positioned below an interference region 74 thereby permitting the cooking chamber 14 to receive a cover 16.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates to a cooking device for use with a barbecue grill.

More specifically, the present invention relates to a cooking device with a curvilinear configuration for use with a cooking chamber of a barbecue grill.

### BACKGROUND OF THE INVENTION

As the popularity of barbecue grills has increased, manufacturers have introduced a multitude of specialized accessories for use in connection with the grills. These accessories include cooking devices with a surface adapted to receive food. Cooking devices generally increase the number and types of foods that can be cooked on the barbecue grills, thereby increasing the utility of the grills. In addition, the cooking device can provide a different technique or method to cook the food. For example, the cooking device can have a generally flat surface such that the device can be used as a skillet, or the cooking device can have a curved surface such that the device can be used as a wok.

Typically, the cooking device is fabricated from metal and is placed on the cooking chamber of the barbecue grill assembly. Specifically, the cooking device is positioned on a rim or outer edge of the cooking chamber. The cooking device is supported in this position by structure which generally extends from the device beyond the rim of the cooking chamber. In addition, the structure extends above the rim of the cooking chamber. This extending structure precludes a lid or cover of the barbecue assembly from engaging the cooking chamber. As a result, the cooking chamber cannot be sealed, thereby compromising the operation and performance of the barbecue grill.

An example of a cooking device susceptible to the problem identified above is U.S. Pat. No. 4,495,861 to Jacks et al. As shown in FIGS. 1-5 therein, the circular cooking device has a generally flat surface, divider flanges, and a plurality of handles extending from an outer edge of the cooking device. The handles support the cooking device over the cooking chamber by engaging a portion of the rim of the cooking chamber. To engage the rim of the cooking chamber, each handle extends beyond the rim. Consequently, the handles prevent the lid of the grill assembly from engaging and sealing the cooking chamber. In addition, since the diameter of the cooking device is less than the diameter of the lower portion, there is an annular void or gap between the cooking device and the rim of the cooking chamber.

Another example of a cooking device with the concerns identified above is a “wok”-style cooking device previously marketed by the Assignee of the present invention. The wok cooking device has a generally annular rim with a recessed portion depending therefrom. The device is positioned on the rim of the cooking chamber wherein a substantial portion of the device extends above the rim. A plurality of braces extends from an exterior surface of the recessed portion and supports the cooking device on the rim. A pair of opposed handles extend beyond the rim of the cooking chamber. Because a substantial portion of the wok cooking device extends above the rim and the handles extend beyond the rim, the lid of the grill assembly cannot engage and seal the lower portion. Like the cooking device of the '861 patent, there is an annular void or gap between the present cooking device and the rim of the cooking chamber.

Therefore, there is a definite need for a cooking device for use in a cooking chamber of a barbecue grill assembly that does not preclude the upper portion from engaging and generally sealing the cooking chamber. In addition, there is a need for a cooking device that does not negatively affect the performance and operation of the barbecue grill assembly.

The present invention is provided to solve these and other problems.

### SUMMARY OF THE INVENTION

The present invention relates to a cooking device or pan for use with a barbecue grill. The cooking device is adapted to be positioned generally within a cooking chamber or firebox of the barbecue grill. A lid or cover mates with the cooking chamber to form a barbecue grill assembly. The cooking device has a generally annular top wall with inner and outer peripheral edges. A generally annular flange depends from the top wall at the outer peripheral edge. The flange has an engaging surface adapted to engage a portion of the inner surface of the cooking chamber. At least one aperture is preferably located in a portion of the flange. Alternatively, the aperture is located in a portion of the top wall. The aperture is adapted to permit a user to grasp the cooking device. The aperture is further adapted to permit the passage of a quantity of heat generated by a heat source in a lower portion of the cooking chamber.

The cooking device has a center portion that is positioned radially inward from the top wall. Preferably, the center portion is recessed from the inner peripheral edge of the top wall such that the cooking device has a generally conical or hemispherical shape. The center portion has a bottom wall that is adapted to prevent unwanted movement of the cooking device when it is placed on a generally planar surface. Such planar surface could include a table or auxiliary cooking burner. The center portion and the bottom wall are adapted to receive a quantity of food to be cooked while the cooking device is positioned within the cooking chamber. Accordingly, the center portion and the bottom wall each have a configuration and dimensions sufficient to receive a measurable quantity of food. The food can then be distributed or spread on the center portion and/or the bottom wall for cooking in a manner similar to “wok” style cooking.

In accord with the invention, the cooking device is positioned within the cooking chamber and above the heat source to define a use position. The cooking device is supported in the use position by frictional engagement between of a portion of the flange engaging surface and a portion of the inner surface of the cooking chamber. Alternatively, the cooking device is supported in the use position by at least one support member extending radially inward from the inner surface. In general terms, the support member is adapted to engage a portion of the flange engaging surface to support the cooking device in the use position.

In the use position, the top wall is in planar alignment with the rim of the cooking chamber and the flange is positioned generally below the rim. When the lid is positioned on the cooking chamber, the rim of the lid engages the rim of the cooking chamber to generally seal the cooking chamber. Thus, the cooking device is entirely within the cooking chamber and, in contrast to conventional cooking accessories, the cooking device does not obstruct or hinder the lid from engaging the cooking chamber. As a result, the performance and operation of the barbecue grill is not compromised or affected.

In the use position, the cooking device is spaced a distance above the heat source, which is generally located in a lower portion of the cooking chamber. Furthermore, in the use position, the cooking device and the cooking chamber define a cavity. The cavity represents a volume within the cooking chamber, which can be increased by increasing the distance between the cooking device and the heat source, or decreased by decreasing the distance between the cooking device and the heat source. As the heat source bums, heat Q is generated and rises through the cavity. A quantity of the heat Q is transferred to the cooking device through the lower surface of the cooking device. The remaining quantity of heat Q is vented or dissipated through the aperture. Accordingly, the aperture is adapted to vent a portion of the heat Q from the cavity and the cooking chamber while food is being cooked on the cooking device.

The dimensions of the cooking device can vary greatly with the dimensions of the grill. Preferably, the dimensions of the cooking device correspond to the internal dimensions of the cooking chamber. In this manner, and in contrast to conventional cooking accessories, the cooking device does not obstruct or hinder the rim of the lid from engaging the rim of the cooking chamber. This provides an important benefit, primarily that the cooking device fits entirely within the cooking chamber such that the cover engages and seals the cooking chamber.

In another preferred embodiment, the cooking device has a flange formed from a plurality of distinct flange segments. As a result, the flange has a discontinuous configuration with a plurality of open areas. The segments generally depend from the outer peripheral edge of the top wall.

In another preferred embodiment, the cooking device has at least one handle. The handle is adapted to enable a user to more easily grasp the cooking device. The handle can be positioned in a number of locations, including the top wall, the flange, or the central portion. The handle is configured such that it does not interfere with the positioning of the cooking device in the cooking chamber. In addition, the handle is adapted not to interfere with the placement of the lid on the cooking chamber.

In yet another preferred embodiment, the cooking device is positioned within an interface plate. The interface plate has a generally rectangular configuration with an aperture that is adapted to receive the cooking device. The interface plate can be used in conjunction with a gas barbecue grill having a generally rectangular cooking chamber. When the cooking device is positioned within the aperture, an annular side wall of the interface plate engages a portion of the exterior surface of the center portion to support the cooking device. Because the cooking device is received by the interface plate and both are positioned within the cooking chamber, the rim of the lid can engage the rim of the cooking chamber to seal the cooking chamber.

Other features and advantages of the invention will be apparent from the following specification taken in conjunction with the following drawings.

### BRIEF DESCRIPTION OF THE DRAWINGS

FIG. 1 is a perspective view of a cooking device of the invention showing the cooking device with a barbecue grill assembly;

FIG. 2 is a perspective view of the cooking device of FIG. 1;

FIG. 3 is a side view of the cooking device of FIG. 1;

FIG. 4 is a top view of the cooking device of FIG. 1;

FIG. 5 is a bottom view of the cooking device of FIG. 1;

FIG. 6 is a partial cross-section view of the cooking device of FIG. 1, showing a lid of the grill assembly positioned above a cooking chamber of the grill assembly;

FIG. 7 is a partial cross-section view of the cooking device of FIG. 1, showing the lid of the grill assembly positioned on the cooking chamber of the grill assembly;

FIG. 8 is a partial detail view of the cooking device of FIG. 1, showing an engaging surface of the device engaging a support member according to FIG. 6;

FIG. 9 is a perspective view of an interface plate for use with the cooking device of FIG. 1;

FIG. 10 is a perspective view of a second cooking device of the invention;

FIG. 11 is a top view of the cooking device of FIG. 9;

FIG. 12 is a perspective view of a third cooking device of the invention, the cooking device having a pair of handles; and,

FIG. 13 is a perspective view of the cooking device of FIG. 12.

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

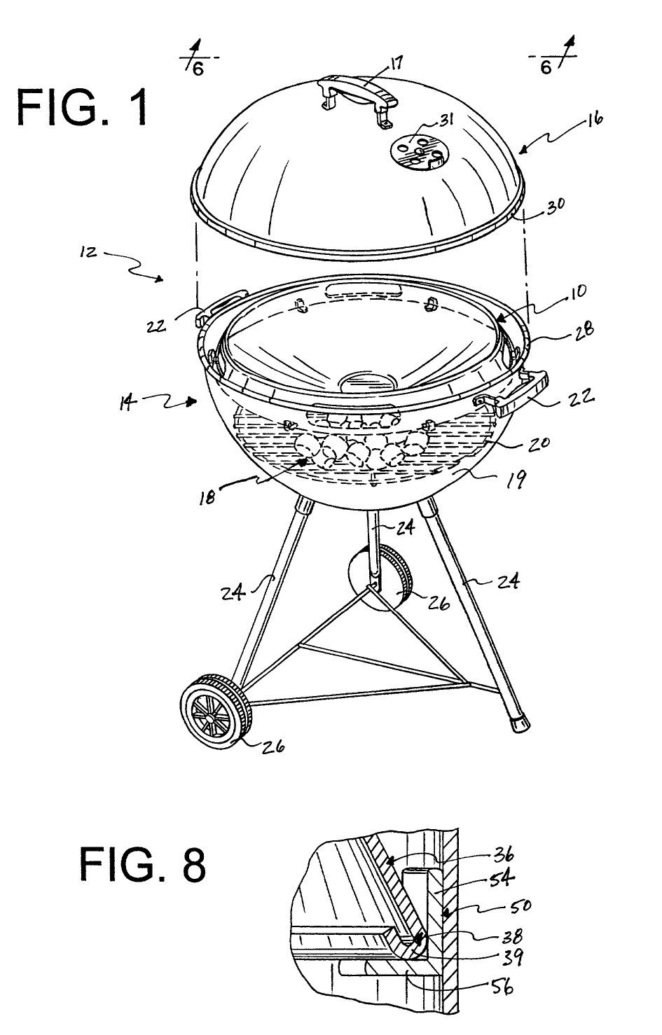

A cooking device or pan 10 for use with a barbecue grill assembly 12 is illustrated in FIG. 1. The grill assembly 12 has a cooking chamber or a lower bowl 14 and a lid 16 adapted to mate with and cover the cooking chamber 14. The cooking device 10 is adapted to be positioned generally within the cooking chamber 14. A handle 17 is attached to the lid 16.

A heat source 18, for example, briquets, is supported by a grate 20 in a lower portion 19 of the cooking chamber 14. The grill 12 includes a pair of handles 22 attached to an outer surface of the cooking chamber 14. A plurality of legs 24 depend from the cooking chamber 14. A plurality of wheels 26 are attached to the grill 12. The cooking chamber 14 has an outer rim 28. An outer rim 30 of the lid 16 is adapted to engage and mate with the rim 28 of the cooking chamber 14 to seal the cooking chamber 14. A movable vent 31 in the lid 16 is adapted to vent the grill assembly 12.

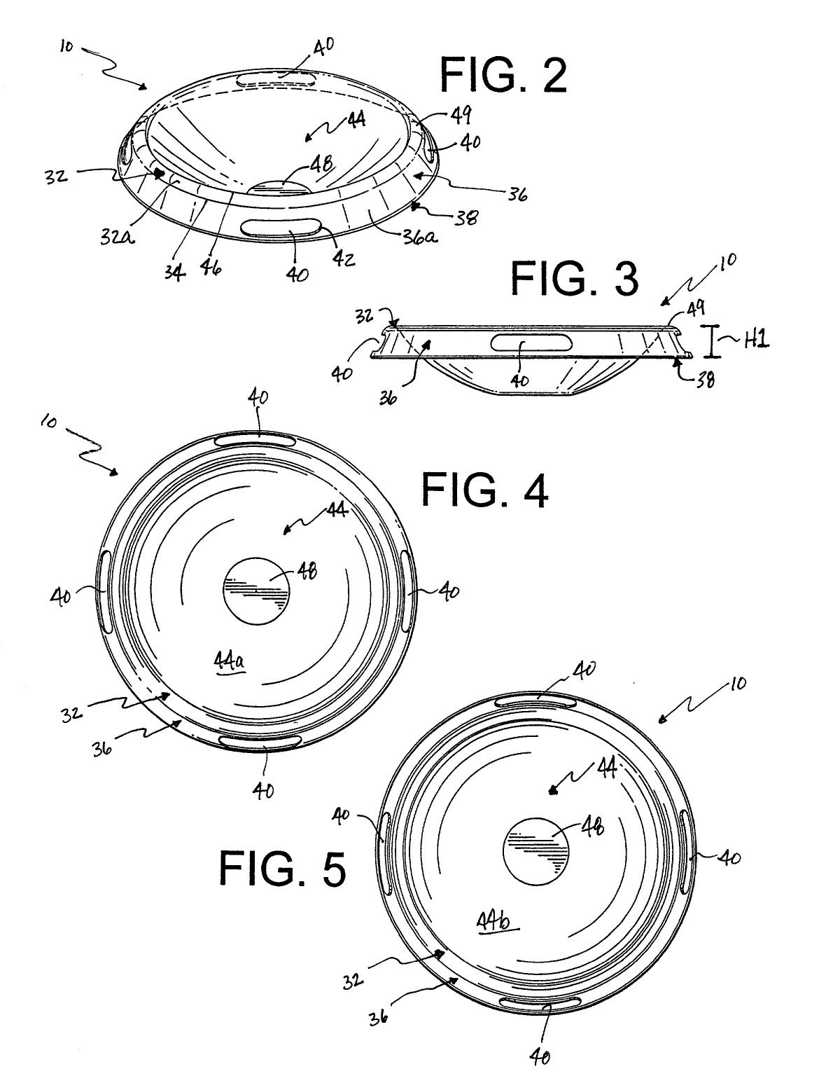

Referring to FIGS. 2-5, the cooking device 10 has a generally annular top wall 32 with a top wall surface 32a. Although the top wall 32 is shown as having a curved surface 32a, the surface 32a can be generally flat or angled. Means for engaging 36 depends from an outer peripheral edge 34 of the top wall 32. The engaging means 36 can be a generally annular flange 36 that is continuous or formed from discontinuous segments. The flange 36 has an engaging surface 38, which as explained below, is adapted to engage or mate with a portion of the interior surface of the cooking chamber 14. In one example of a preferred embodiment, the flange 36 is integral with the top wall 32. The flange 36 has a flange surface 36a, which can be curved or generally flat. Preferably, the engaging surface 38 terminates with a rolled edge or lip 39 (see FIG. 8).

At least one aperture 40 is located in a portion of the flange 36. Alternatively, the aperture 40 is located in a portion of the top wall 32. The aperture 40 is adapted to permit a user to grasp the cooking device 10. The aperture 40 is further adapted to permit the passage of a quantity of heat generated by the heat source 18 when the cooking device 10 is positioned within the cooking chamber 14. In this manner, the aperture 40 vents the heat generated by the heat source 18. The aperture 40 has an edge 42 that defines the shape of the aperture 40. Although shown in FIG. 2 as having an oval or obround shape, the aperture 40 can have a variety of shapes, including but not limited to circular, square, or rectangular. The quantity and configuration of apertures 40 can vary with the numerous design parameters of the cooking device 10.

As shown in FIGS. 2-5, the cooking device 10 has a central portion 44 that is positioned radially inward from an inner peripheral edge 46 of the top wall 32. Described in a different manner, the flange 36 extends radially outward relative to the central portion 44. The central portion 44 has a generally smooth cooking surface 44a and an exterior surface 44b. Preferably, the central portion 44 is recessed such that the cooking device 10 has a generally conical or hemispherical shape. Described in a different manner, the cooking device 10 has a curvilinear configuration when viewed in cross-section. The degree of recess or curvature of the central portion 44 can vary with the design parameters of the cooking device 10. In alternate configuration, the top wall 32 is omitted from the cooking device 10. In this configuration, the flange 36 extends radially outward from the peripheral edge 46.

The central portion 44 has a bottom wall 48 that is adapted to prevent unwanted movement of the cooking device 10 when it is placed on a generally planar surface. Such planar surface could include a table or auxiliary cooking burner. Accordingly, the bottom wall 48 has a generally flat or linear configuration. Alternatively, the bottom wall 48 has a curvilinear configuration. The central portion 44 and the bottom wall 48 are adapted to receive a quantity of food to be cooked while the cooking device 10 is positioned within the cooking chamber 14. Accordingly, the central portion 44 and the bottom wall 48 each have a configuration and dimensions sufficient to receive a measurable quantity of food. In addition, the surface 44a is adapted to facilitate the cooking of food placed on the central portion 44. The food can then be distributed or spread on the central portion 44 and/or the bottom wall 48 for cooking in a manner similar to “wok” style cooking.

Referring to FIG. 3, the top wall 32 defines an uppermost surface 49 of the cooking device 10. The uppermost surface 49 can be generally flat or rounded. The uppermost surface 49 is positioned at a height H1 above the engaging surface 38 of the flange 36. As shown in FIG. 3, the height H1 is the distance between the engaging surface 38 and the uppermost surface 49. The height H1 can vary with the design parameters of the cooking device 10, including but not limited to the top wall 32, the flange 36, and the central portion 44. However, the height H1 is adapted to permit the cooking chamber 14 to be covered by the lid 16 without any interference from the cooking device 10. Described in a different manner, the height H1 should not be so great as to prevent the lid 16 from engaging and mating with the cooking chamber 14 when the cooking device 10 is positioned within the cooking chamber 14.

As shown in FIGS. 1, 6 and 7, the cooking device 10 is removably positioned within the cooking chamber 14 and above the heat source 18 to define a use position. The cooking device 10 is supported in the use position by at least one support member or tab 50. Due to the recessed nature of the central portion 44, a substantial portion of the device 10 depends into the cooking chamber 14. Referring to FIG. 8, the support member 50 is affixed to an inner surface 52 of the cooking chamber 14 and extends radially inward therefrom. The support member 50 is adapted to engage and support a portion of the flange 36 and/or engaging surface 38. Although shown in FIG. 8 as having a generally “L-shaped” configuration with a vertical segment 54 and a horizontal segment 56, the support member 50 can have various configurations depending on the design parameters of the flange 36 and the rim 38. In the event that the support member 50 lacks the vertical segment 54, a portion of the flange 36 engages a portion of the horizontal segment 56 and/or the inner surface 52 of the cooking chamber 14. In addition to being adapted to engage and support the cooking device 10, the support member 50 is adapted to engage and support a cooking grate (not shown) that is removed from the cooking chamber 14 before the cooking device 10 is inserted therein.

Alternatively, the cooking device 10 is supported in the use position by the engagement of a portion of the engaging surface 38 with a portion of an inner surface 52 of the cooking chamber 14. Accordingly, the dimensions and configuration of the cooking device 10 and the flange 36 closely correspond to the interior dimensions of the cooking chamber 14.

In one example of a preferred embodiment, the cooking device 10 is entirely within the grill 12 and in contrast to conventional cooking accessories, the cooking device 10 does not obstruct or hinder the lid 16 from engaging and mating with the rim 28 of the cooking chamber 14.

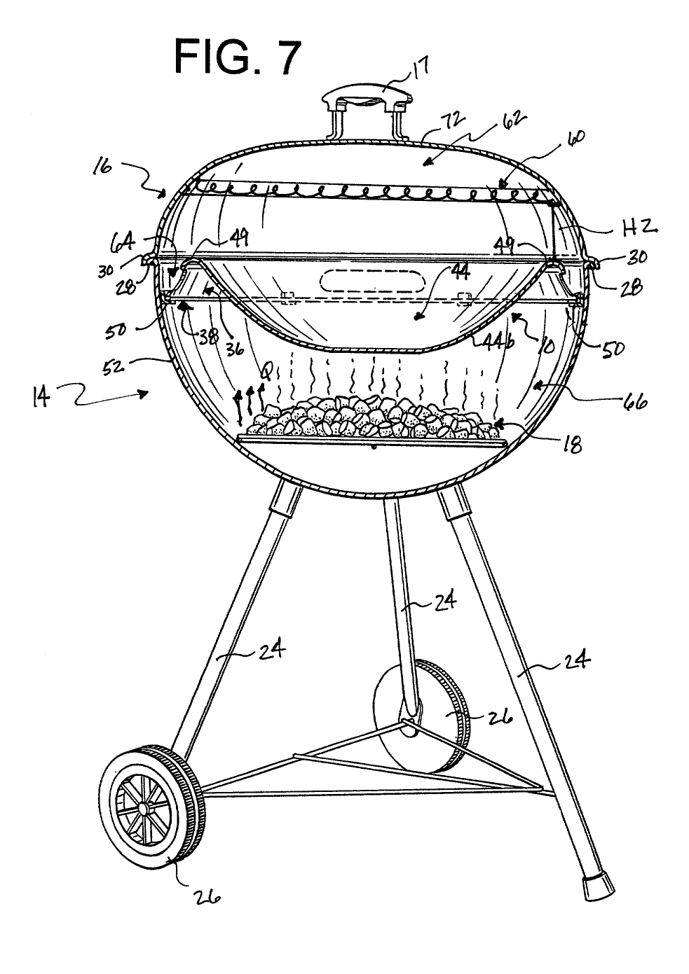

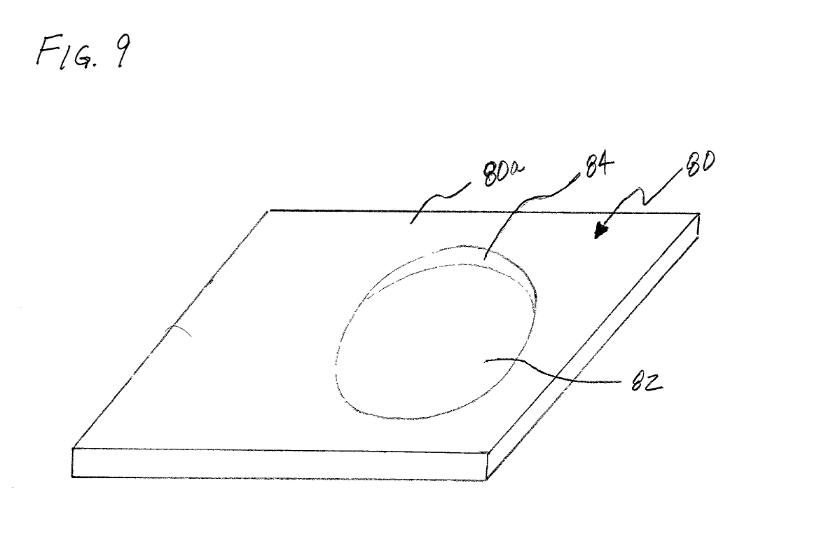

As shown in FIG. 7, an interference region 60 is found within a cavity 62 of the lid 16. The interference region 60 has a generally annular configuration which generally corresponds to the annular configuration of the top wall 32. The interference region 60 is spaced a vertical distance H2 above the uppermost surface 49 of the top wall 32. The size, configuration, and vertical position of the interference region 60 will vary with the configuration of the lid 16, the top wall 32, and the uppermost surface 49. When the cooking device 10 is in the use position, the uppermost surface 49 is below the interference region 60 and the lid 16 can engage and mate with the cooking chamber 14. In the event that a portion of the uppermost surface 49 engages a portion of the interference region 60, the lid 16 cannot engage and mate with the cooking chamber 14. As a result, the cooking chamber 14 is not sealed and the cooking performance of the grill assembly 10 is compromised.

Although the uppermost surface 49 is shown in FIG. 7 as being in planar alignment with the rim 28 of the cooking chamber 14, the cooking device 10 can be positioned a distance below the rim 28. In addition, the cooking device 10 can be positioned above the rim 28; however, to prevent the uppermost surface 49 from obstructing the engagement of the lid 16 and the cooking chamber 14, the uppermost surface 49 should be positioned below the interference region 60. Accordingly, the interference region 60 represents a boundary region for the uppermost surface 49, above which the lid 16 cannot engage and seal the cooking chamber 14.

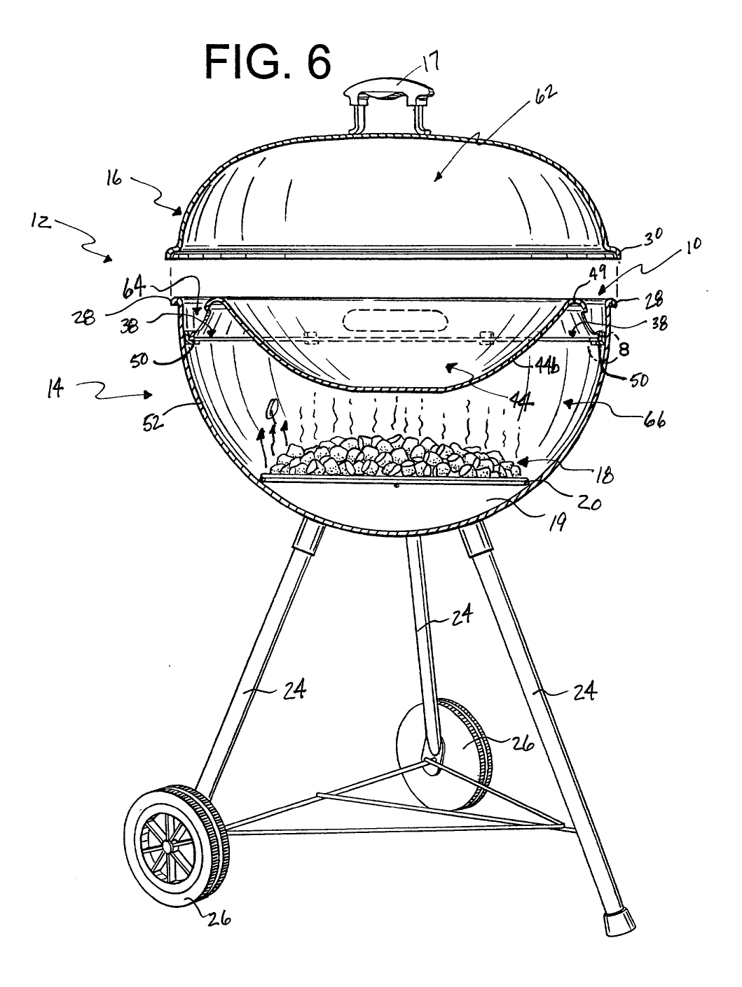

Referring to FIGS. 6 and 7, in the use position, a trough 64 is formed between the flange 36 and the inner surface 52 of the cooking chamber 14 near the rim 28. Although shown as being generally annular, the configuration of the trough 64 varies with the design parameters of the device 10 and the positioning of the cooking device 10 within the cooking chamber 14. The configuration of the trough 64 is increased when the cooking device 10 is positioned further below the rim 28 of the cooking chamber 14. Conversely, the configuration of the trough 64 is decreased when the cooking device 10 is positioned closer to the rim 28.

In the use position, the cooking device 10 is spaced a distance above the heat source 18. More specifically, the central portion 44, the flange 36, and the bottom wall 48 are spaced a distance from the heat source 18 to define a cavity 66. The cavity 66 represents a volume within the cooking chamber 14, and is defined or bounded by the heat source 18, the inner surface 52 of the cooking chamber 14, and a lower surface 54 of the cooking device 10. The volume of the cavity 66 can be increased by increasing the distance between the cooking device 10 and the heat source 18, or decreased by decreasing the distance between the device 10 and the heat source 18.

As the heat source 18 bums, heat Q is generated and rises through the cavity 60. A quantity of the heat Q is transferred to the cooking device 10 through the lower surface 54. The remaining quantity of heat Q is vented or dissipated through the aperture 40. Accordingly, the aperture 40 is adapted to vent a portion of the heat Q from the cavity 60 while food is being cooked on the cooking device 10. The quantity of heat vented by the aperture 40 varies with the design parameters of the device, including the number of apertures 40 in the cooking device 10 and the size or configuration of the aperture 40. Accordingly, a greater amount of heat is vented when the number of apertures 40 is increased and/or the configuration of the apertures 40 is increased.

The rim 28 of the cooking chamber 14 defines a first perimeter P1 and the engaging surface 38 of the flange 36 defines a second perimeter P1. Unlike conventional devices, the cooking device 10 is adapted to be positioned entirely within the first perimeter P1 As a result, no part of the cooking pan 10 extends beyond or exceeds the perimeter of the perimeter defined by the rim 28. Consequently, the diameter of the cooking device 10 generally corresponds to the diameter of the cooking chamber 14 and/or cooking chamber 14. The remaining dimensions, for example the flange 36 height and the depth of the central portion 44, can vary greatly with the dimensions of the grill 12. The cooking device 10 has a generally hemispherical configuration when the cooking chamber 14 has a round configuration. Similarly, the cooking device 10 has a generally rectangular configuration when the cooking chamber 14 has a rectangular configuration. In this manner and in contrast to conventional cooking accessories, the cooking device 10 does not obstruct or hinder the rim 30 of the lid 16 from engaging the rim 28 of the cooking chamber 14. This provides an important benefit, primarily that the cooking device 10 fits entirely within the cooking chamber 14 such that the cover 16 engages the cooking chamber 14 to seal the cooking chamber 14.

The cooking device 10 can be manufactured from steel, aluminum, or other metals, including metal alloys. The cooking device 10 can be formed in a number of ways, including cast or stamped processes. The material used to fabricate the cooking device 10 should permit heat transfer from the heat source 18 to the food cooked on the cooking device 10.

The cooking device 10 is adapted for use with an outdoor cooking assembly (not shown) having an auxiliary burner. The burner is connected to either a mobile cart or a portion of a barbecue grill assembly. In the former, the burner is supported on a mobile cart formed from a plurality of frame members. In the latter, the burner is supported by a plurality of frame members in a position external to the cooking chamber. In either situation, the burner has a support grate or ring adapted to support a cooking pot or pan. The cooking device 10 of the present invention can be used in conjunction with the burner by positioning the device 10 on the support ring. Specifically, the generally flat bottom wall 48 of the central portion 44 engages the support ring and provides stability to the cooking device 10 while food is cooked in the device 10. Because the cooking device 10 can be positioned in the cooking chamber 14, on a cart-mounted burner, or on externally-mounted burner, the versatility of the cooking device 10 is significantly increased. Accordingly, the value of the cooking device 10 to a user is similarly increased.

In another preferred embodiment, the L-shaped support member 50 is omitted from the cooking chamber 14 and the inner surface 52 has means for supporting the cooking device 10 in the use position. The supporting means can be an annular or discontinuous ledge integrated with the inner surface 52. The ledge can engage a portion of the flange 36 or a portion of the exterior surface 44b of the central portion 44. Alternatively, the supporting means is a groove or a channel formed in the inner surface 52 that receives a portion of the flange 36. In yet another alternative, the supporting means is a brace or plurality of braces extending radially inward from the inner surface 52 with a depending segment that engages a portion of the exterior surface 44b of the central portion 44.

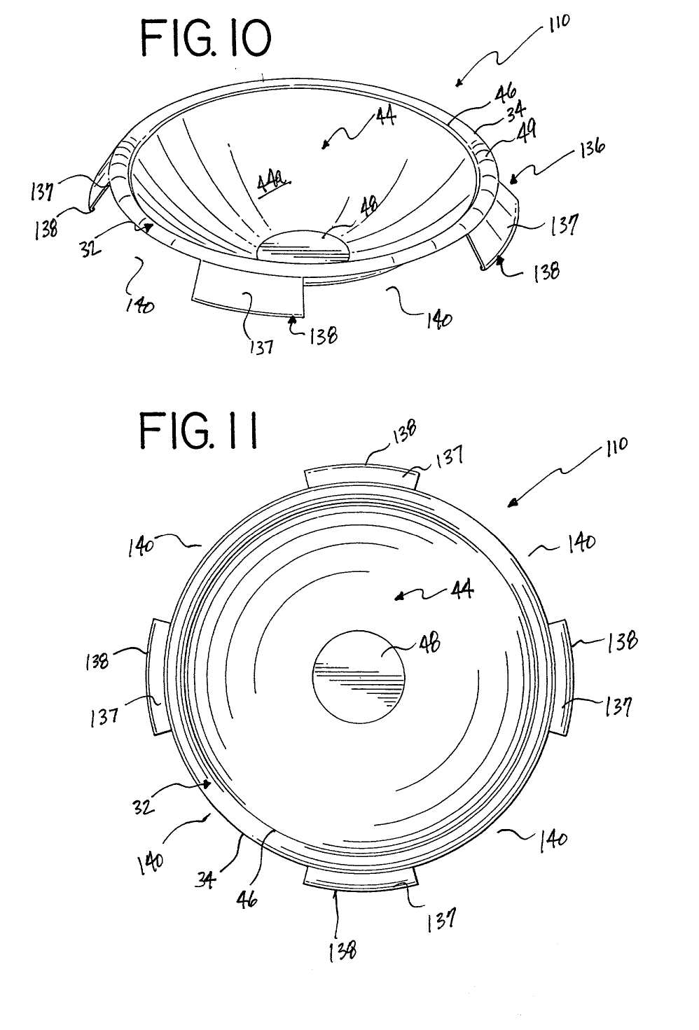

Referring to FIG. 9, the cooking device 10 can be positioned within an interface plate 80 which is adapted for use within conventional generally-rectangular gas barbecue grill. The interface plate 80 has a generally rectangular configuration with an aperture 82 that is adapted to receive the cooking device 10. When the cooking device 10 is positioned within the aperture 82, an annular side wall 84 engages a portion of the exterior surface 44b of the central portion 44 and/or the flange 36 to support the cooking device 10. Alternatively, a portion of the flange 36 engages an upper surface 80a of the interface plate 80. The aperture 82 can be positioned in a central portion of the interface plate 80, or in a peripheral peripheral portion (as shown).

The interface plate 80 can be used in conjunction with a gas barbecue grill (not shown) having a generally rectangular cooking chamber defined by a cover and a firebox. A heat source is located in a lower portion of the firebox. The conventional metal grate(s) is removed from the cooking chamber and the interface plate 80 is positioned therein. The cooking device 10 is then placed in the aperture 82 and supported above the heat source. Because the cooking device 10 is received by the interface plate 80 and both are positioned within the firebox, the cover can engage the firebox to seal the cooking chamber.

In another preferred embodiment shown in FIGS. 10 and 11, the cooking device 110 has a flange 136 formed from a plurality of distinct segments 137. In comparison to the flange 36 shown in FIGS. 2-5, the flange 136 has a discontinuous configuration with open areas 140. The segment 137 depends from the peripheral edge 34 of the top wall 32. The segment 137 has an engaging surface 138. The segment 137 is adapted to permit a user to grasp the cooking device 110. The number of segments 137 and the configuration of such varies with the design parameters of the cooking device 110 and the cooking chamber 14.

As discussed above, the cooking device 110 is positionable within the grill 12 and above the heat source 18 to define a use position. The cooking device 110 is supported in the use position by the engagement between the engaging surface 138 and at least one support member 50. Alternatively, the cooking device 110 is supported in the use position by the frictional engagement of the engaging surface 138 with a portion of the inner surface 52 of the cooking chamber 14. The open area 140 is adapted to permit the passage of a quantity of heat Q generated by the heat source 18 when the cooking device 110 is in the use position.

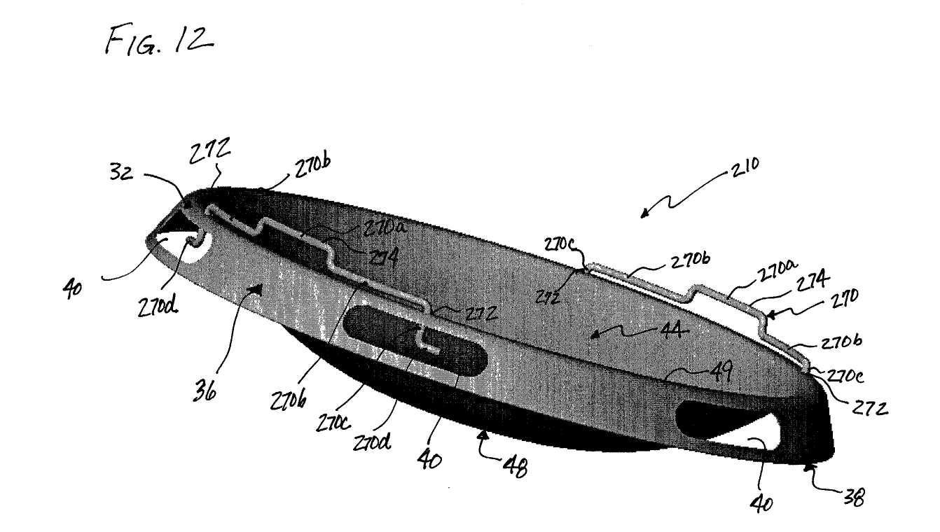

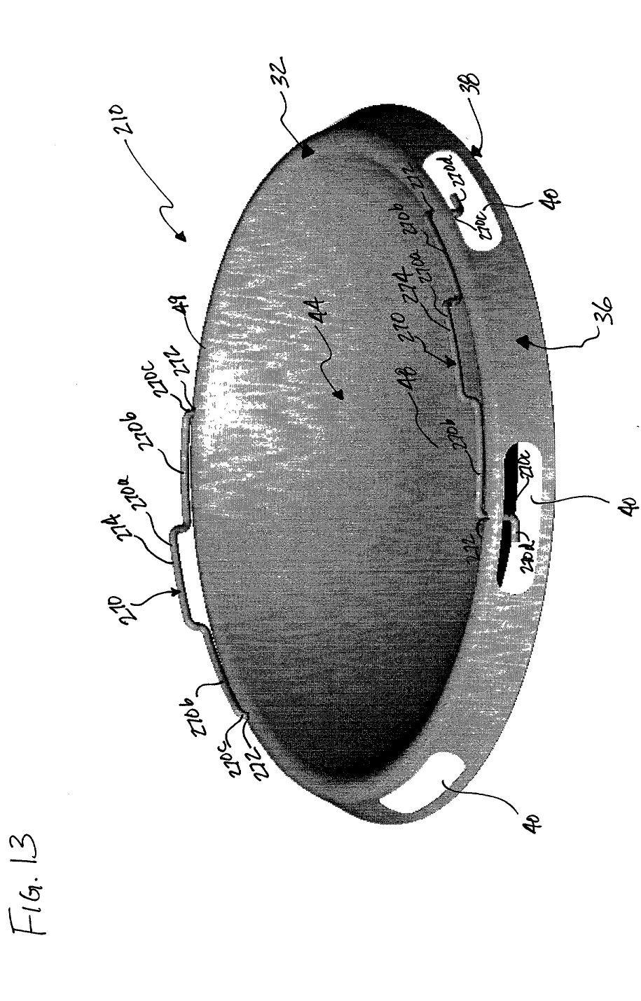

In another preferred embodiment in FIGS. 12 and 13, the cooking device 210 includes at least one handle 270. The handle 270 is adapted to enable a user to more easily grasp the cooking device 210 such that it can be placed in or removed from the cooking chamber 14. The handle 270 can be positioned in a number of locations, including the top wall 32, the flange 36, or the central portion 44. As shown in FIG. 11, the handle 270 has a generally horizontal first segment 270a between two generally horizontal second segments 270b. A generally vertical third segment 270c extends through and past an aperture 272 in the top wall 32. A generally horizontal fourth segment 270d prevents disengagement of the handle 270 when the user engages and extends the handle 270. The handle 270 is extendable a distance in a generally vertical direction when a user engages the first segment 270a and/or the second segments 270b. When the user disengages the segments 270a, 270b, the handle 270 retracts the distance such that the handle 270 is positioned adjacent an upper surface (not shown) of the top wall 32. Described in different terms, when disengaged by the user, the handle 270 is generally flush with the top wall 32.

The handle 270 is adapted not to interfere with the positioning of the cooking device 210 in the cooking chamber 14. In addition, the handle 270 is adapted not to interfere with the placement of the lid 16 on the cooking chamber 14 when the cooking device 210 is positioned within the cooking chamber 14. As disclosed above, the top wall 32 defines a first uppermost surface 49, which is below the interference region 60 thereby permitting the cooking chamber 14 to receive the cover 16. The handle 270 defines a second uppermost surface 274 which, like the first uppermost surface 49, is positioned at a height above the flange 36. The position of the second uppermost surface 274 depends upon the position of the handle 270. When the handle 270 is disengaged and the device 210 is in the use position, the second uppermost surface 274 is positioned below the interference region 60 thereby permitting the cooking chamber 14 to receive the cover 16.

Preferably, when the device 210 is in the use position, no portion of a disengaged handle 270 makes contact with the rim 28 or extends past a perimeter (not shown) of the cooking chamber 14 defined by the rim 28. Once engaged and extended by the user, a portion of the handle 270 may extend a distance above a generally horizontal plane defined by the rim 28 of the cooking chamber 14.

While the specific embodiments have been illustrated and described, numerous modifications come to mind without significantly departing from the spirit of the invention and the scope of protection is only limited by the scope of the accompanying claims.

I claim:

1. A cooking device for use with a cooking chamber of a barbecue grill, the cooking device comprising:
a curvilinear central portion having a cooking surface; and,
an annular flange extending from an outer edge of the central portion, the flange adapted to engage an inner surface of the cooking chamber and support the cooking device above a heat source positioned in a lower portion of the cooking chamber.

2. The cooking device of claim 1 further comprising at least one aperture in the flange wherein the aperture is adapted to permit a user to grasp the cooking device.

3. The cooking device of claim 1 further comprising at least one handle adapted to permit a user to grasp the cooking device.

4. The cooking device of claim 1 wherein the central portion has a generally flat bottom wall.

5. The cooking device of claim 1 including a top wall positioned radially outward of the central portion.

6. The cooking device of claim 1 wherein the annular flange is comprised of a plurality of flange segments extending radially outward relative to the central portion.

7. The cooking device of claim 1 wherein the annular flange extends radially outward relative to the central portion.

8. The cooking device of claim 5 wherein the top wall is positioned at a height above the flange, the height being adapted to permit the cooking chamber of the barbecue grill to be covered by a lid without interference by the cooking device.

9. A cooking device for use within a cooking chamber of a barbecue grill, the cooking device comprising:
a generally annular top wall;
a central portion recessed from the top wall, the central portion having a curvilinear cooking surface; and,
at least one flange extending from the top wall, the at least one flange adapted to engage an inner surface of the cooking chamber and support the cooking device in the cooking chamber.

10. The cooking device of claim 9 wherein the flange is a circumferential body including at least one aperture adapted to permit a user to grasp the cooking device.

11. The cooking device of claim 9 further comprising at least one handle adapted to permit a user to grasp the cooking device, the handle operably connected to the top wall.

12. The cooking device of claim 9 wherein the central portion has a generally flat bottom wall.

13. The cooking device of claim 9 wherein the top wall defines an uppermost surface of the cooking device, the uppermost surface being positioned at a height above the flange.

14. The cooking device of claim 13 wherein the uppermost surface is below an interference region thereby permitting the cooking chamber to receive a cover.

15. The cooking device of claim 9 wherein the at least one flange has an engaging surface adapted to mate with a support structure of the cooking chamber.

16. The cooking device of claim 15 wherein the top wall defines an uppermost surface of the cooking device, the uppermost surface being positioned at a height above the engaging surface.

17. The cooking device of claim 16 wherein the uppermost surface is below an interference height defined by a lid positioned over the cooking device thereby permitting the cooking chamber to receive a cover.

18. An outdoor cooking assembly comprising:
a barbecue grill assembly having a cooking chamber and a mating lid, the cooking chamber having a heat source positioned in a lower portion of the cooking chamber;
a cooking pan removably positioned within the cooking chamber, the cooking pan having a curvilinear central portion with a cooking surface, the cooking pan having a flange extending from an outer edge of the central portion, the flange having an engaging surface; and,
at least one support member positioned on an inner surface of the cooking chamber, the support member adapted to engage a portion of the engaging surface to support the cooking pan.

19. The outdoor cooking assembly of claim 18 further comprising at least one aperture in the flange, the aperture adapted to permit a user to grasp the cooking pan.

20. The outdoor cooking assembly of claim 18 wherein the engagement of the flange and the support member forms a cavity in the cooking chamber.

21. The outdoor cooking assembly of claim 20 wherein the cavity is generally bounded by the heat source and the cooking pan.

22. The outdoor cooking assembly of claim 18 wherein the support member is a ledge extending inward from the inner surface of the cooking chamber.

23. The outdoor cooking assembly of claim 18 wherein the support member is a tab extending inward from the inner surface of the cooking chamber.

24. An outdoor cooking assembly comprising:
a barbecue grill assembly having a cooking chamber and a mating lid, the cooking chamber having a heat source positioned in a lower portion of the cooking chamber;
at least one support member extending inward from an inner surface of the cooking chamber; and,
a cooking pan removably positioned within the cooking chamber, the cooking pan having a curvilinear central portion with a cooking surface, the cooking pan having means for engaging the support member to support the cooking pan, the engaging means extending from an outer edge of the central portion.

25. The outdoor cooking assembly of claim 24 wherein the engaging means includes at least one aperture, the aperture adapted to permit a user to grasp the cooking pan.

26. The outdoor cooking assembly of claim 24 wherein the engaging means is positioned below a rim of the cooking chamber.

27. The outdoor cooking assembly of claim 24 wherein the engaging means includes an engaging surface, the engaging surface positioned below a rim of the cooking chamber.

28. The outdoor cooking assembly of claim 24 wherein a rim of the cooking chamber defines a perimeter, the cooking pan positioned entirely within the perimeter.

29. The outdoor cooking assembly of claim 24 wherein the cooking pan does not extend beyond a perimeter defined by a rim of the cooking chamber.

30. A cooking device for use within a cooking chamber of a barbecue grill, the cooking chamber having a rim defining a perimeter, the cooking device comprising:
a curvilinear central portion having a cooking surface; and,
a generally annular flange extending radially from an outer edge of the central portion, the flange having at least one engaging surface adapted to engage an inner surface of the cooking chamber and support the cooking device in the cooking chamber, the at least one engaging surface defining a perimeter which is less than the perimeter of the cooking chamber.

31. The cooking device of claim 30 wherein the flange has at least one aperture adapted to permit a user to grasp the cooking device.

32. The cooking device of claim 30 wherein the central portion has a generally flat bottom wall.

33. The cooking device of claim 30 wherein the flange is comprised of a plurality of flange segments extending radially from the outer edge of the central portion.

34. The cooking device of claim 30 wherein the flange is entirely within the perimeter of the cooking chamber when the cooking device is positioned in the cooking chamber.

35. The cooking device of claim 30 wherein no portion of the flange extends past the perimeter of the cooking chamber when the cooking device is positioned in the cooking chamber.

36. A cooking device for use within a cooking chamber of a barbecue grill, the cooking device comprising:
a curvilinear central portion having a cooking surface; and,
a generally annular flange extending radially from an outer edge of the central portion, the flange having at least one engaging surface adapted to engage an inner surface of the cooking chamber and exclusively support the cooking device in the cooking chamber.

37. The cooking device of claim 36 wherein the flange has at least one aperture adapted to permit a user to grasp the cooking device.

38. The cooking device of claim 36 wherein the central portion has a generally flat bottom wall.

39. The cooking device of claim 36 wherein the flange is comprised of a plurality of flange segments extending radially from the outer edge of the central portion.
